(19) United States
(12) Patent Application Publication
(10) Pub. No.: US 2015/0303503 A1
(43) Pub. Date: Oct. 22, 2015

(54) COMPUTING DEVICE

(71) Applicant: INTELLIGENT ENERGY LIMITED, Leicestershire (GB)

(72) Inventor: Henri WINAND, Loughborough, Leicestershire (GB)

(73) Assignee: INTELLIGENT ENERGY LIMITED, Leicestershire (GB)

(21) Appl. No.: 14/648,672

(22) PCT Filed: Dec. 2, 2013
(86) PCT No.: PCT/GB2013/053186

§ 371 Date: May 29, 2015

(30) Foreign Application Priority Data
Dec. 4, 2012 (GB) 1221815.2

(51) Int. Cl. H01M 8/06; H01M 8/02; H01M 8/04; G06F 1/18; G06F 1/20

(52) U.S. Cl. CPC H01M 8/0687; G06F 1/189; G06F 1/181; G06F 1/20; H01M 8/04201; H01M 8/04007; H01M 8/0271; H01M 2250/30

(57) ABSTRACT

The invention relates to a computing device comprising: an outer covering having at least a first portion which is an oxygen-permeable microstructure, wherein the first portion is integrally formed with the outer covering; an electronic component within the outer covering; and a fuel cell with an oxidant inlet that is in fluid communication with the first portion of the outer covering.

The invention relates to the field of computing devices that can be powered by an internal fuel cell.

Conventional computing devices, such as laptop computers, typically comprise one or more ventilation openings. Openings in the computing device allow air to be: drawn into the device; used to cool a component of the device; and expelled from the device. Typically, a grille may be used to separate a user of a computing device from a fan that is used to direct air through the opening. The grille can also prevent debris from the environment from being drawn into the device.

Numerous drawbacks are encountered with computing devices that comprise ventilation apertures or grille-covered openings, for example:
apertures may allow foreign objects that are smaller than the aperture to be drawn into the device;
grille-covered openings or apertures may allow dust to be drawn into the device;
grille-covered openings or apertures may allow the rapid ingress of liquids such as water into the device;
grille-covered openings or apertures can lack aesthetic appeal;
grille-covered openings or apertures may allow fan noise to be emitted from the device with little attenuation; and
grilles may contain weak mechanical links that are susceptible to damage.

Alternatively, other computing devices, such as some mobile telephones, operate at low power and do not require convection cooling and so can be provided without a ventilation opening. Such devices do not exhibit the problems experienced by computing devices that comprise grille-covered openings or apertures. However, such a solution is not applicable to all classes of computing device. In some circumstances, it is necessary to allow fluids to enter the device from the environment.

Fuel cells can also be incorporated into computing devices in order to provide a mobile power source. A fuel cell within the computing device requires oxidant and fuel. It can be convenient to obtain oxidant from the air of the surrounding environment, rather than storing the oxidant within the device. A device incorporating a fuel cell can be provided with an opening to allow air to be drawn from the environment into an oxidant inlet of the fuel cell. For this reason, such a computing device may be provided with an opening, even if the computing components of the device do not require convection cooling, and so the computing device suffers from the limitations related to the use of ventilation openings and grilles.

A computing device comprising:
an outer covering having at least a first portion which is an oxygen-permeable microstructure, wherein the first portion is integrally formed with the outer covering;
an electronic component within the outer covering; and
a fuel cell with an oxidant inlet that is in fluid communication with the first portion of the outer covering.

The first portion of the outer covering may provide a structural support to the electronic component and/or the fuel cell. The first portion of the outer covering may provide mechanical protection to the electronic component and/or the fuel cell. The first portion of the outer covering may be rigid.

The outer covering may have a second portion which is a microstructure that provides a lower oxygen permeability than the first portion. The second portion may be integrally formed with the outer covering and/or the first portion. The second portion may have a substantially non-oxygen-permeable microstructure.

The outer covering may have no visible apertures. The outer covering may be a unitary structure.

The oxygen-permeable microstructure of the first portion may comprise pores or apertures with a mean length less than one of 0.1, 0.5, 1, 2, 5, 10 or 20 microns in their longest dimension in a plane of the exterior surface of the covering. The pores or apertures may be arranged in an ordered pattern.

The outer covering is typically formed of at least one solid material and may comprise one or more of: a porous sintered material; carbon fibre; metallised porous plastic; pierced metallic material; a metal or alloy; porous graphite; woven metallic fibre; metallised porous glass; stainless steel; aluminium possibly with protective coating; plastic; carbon fibre; a composite material; porous glass; a ceramic; or metallic coated materials.

The oxidant inlet of the fuel cell may be provided on an oxidant inlet face of the fuel cell. The oxidant inlet face of the fuel cell may be integrated with the first portion of the outer covering.

The computing device may comprise a fan. The fan may be configured to direct air through the first portion of the outer covering into the oxidant inlet of the fuel cell.

The computing device may comprise a first fluid flow path and a second fluid flow path. The first fluid flow path may be provided between the fan and the electronic component. The second fluid flow path may be provided between the fan and the oxidant inlet of the fuel cell. The fan may be configured to direct air into the first and second fluid flow paths.

The first portion of the outer covering may provide a structural support to the electronic component or the fuel cell. The outer covering may be in thermal contact with the fuel cell or the electronic component. The outer covering may be configured to conduct heat from the fuel cell or the electronic component so as to maintain a suitable operating temperature of the device. The fan may be situated between the first portion of the outer covering and the oxidant inlet. The first portion of the outer covering may comprise a chemical filter.

The first portion of the outer covering may be configured to filter, from an air stream passing between an exterior of the outer covering and the oxidant inlet of the fuel cell, at least one of: aromatic compounds; hydrocarbons; carbon monoxide; sulphur compounds; volatile organic compounds (VOCs); oxides of nitrogen and particulate matter.

The fuel cell may be a fuel cell stack. The first portion of the outer covering may provide a compression plate of the fuel cell stack.

The outer covering may have a hydrophilic core configured to wick water from the fuel cell. The outer covering may have a hydrophobic coating to prevent water ingress into the device.

The outer covering may have no visible apertures. The electronic component of the computing device and/or the fuel cell may be partially or completely enclosed within (be partly or entirely within) the outer covering. A partial enclosure may mean that the electronic component and/or the fuel cell is at least partially within a region defined by two or more surfaces of the outer covering.

The optional features described above with regard to the first aspect or below with regard to any example herein may also be provided with another computing device.

According to a second aspect of the invention there is provided a computing device comprising:
an outer covering comprising a material having:
   a first portion having an oxygen-permeable microstructure, and
   a second portion having a microstructure that is substantially non-oxygen-permeable; and
a fuel cell with an oxidant inlet that is in fluid communication with the first portion of the outer covering.

Also disclosed is a computing device comprising: an outer covering with no visible apertures and having an oxygen-permeable microstructure; and a fuel cell with an oxidant inlet that is integrated with the outer covering.

Also disclosed is a computing device comprising an outer covering having an oxygen-permeable microstructure and a fuel cell with an oxidant inlet that is in fluid communication with the outer covering.

Embodiments of the present invention will now be described by way of example and with reference to the accompanying drawings in which:

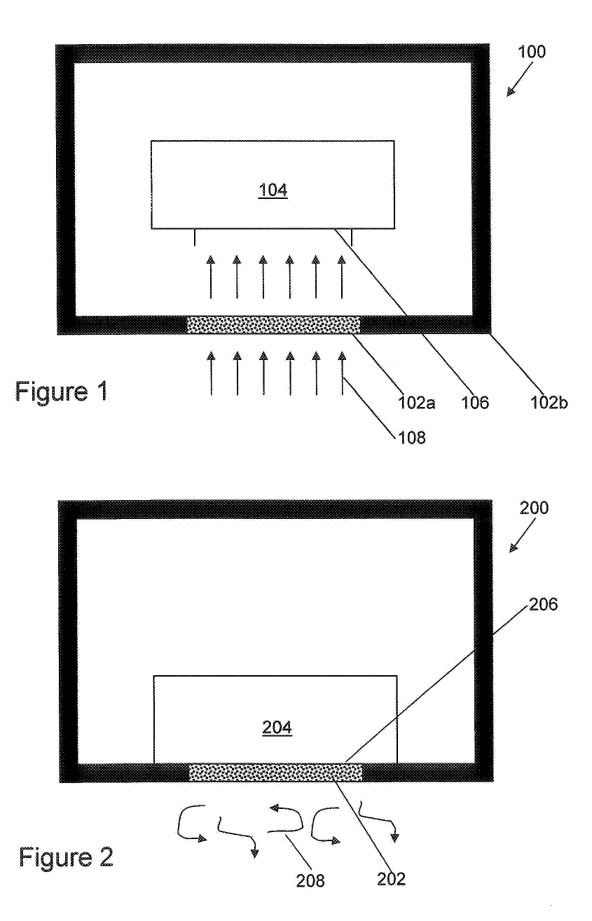

FIG. 1 illustrates a device comprising an outer covering and a fuel cell;

FIG. 2 illustrates a device comprising an outer covering and a fuel cell integrated with the outer covering;

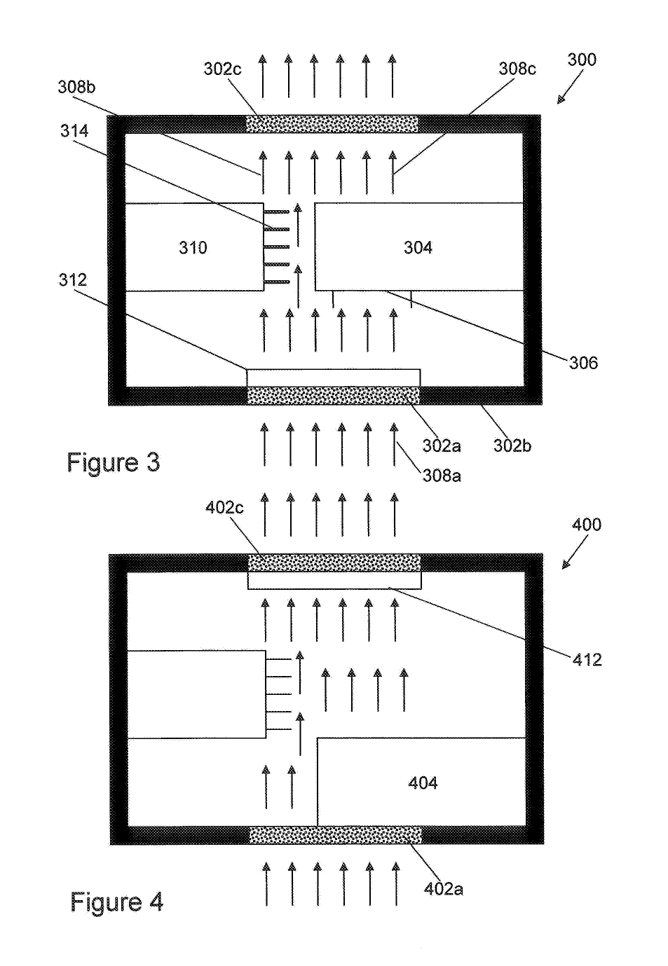

FIG. 3 illustrates a device comprising an outer covering, an electronic component, a fan and a fuel cell; and

FIG. 4 illustrates a device comprising an outer covering, an electronic component, a fan and a fuel cell integrated with the outer covering.

The present invention relates to a computing device that comprises a fuel cell. The device also comprises an outer covering through which air can be drawn into the fuel cell without the need for grilles or visible apertures. The computing device may be a consumer electronics device such as a computer, digital camera, electronic book, personal media player, smart phone, navigation device, or mobile telephone. Types of computer include laptop computers, personal digital assistants (PDA), desktop computers and tablet computers, for example. In some examples, the computing device can be any device that provides a data processing capability.

In some examples, a micro-porous covering, fabric covering or micro-perforated covering is provided. The covering can allow air to diffuse through the covering to provide oxidant to the fuel cell. The fuel cell may therefore be placed within the covering of the computing device without the requirement for providing visible apertures for air access. The provision of such a covering can improve the appearance and limit the ingress of dust into the computing device.

The expression ‘covering’ used here is intended to encompass any form of protective enclosure or part enclosure for the device including a housing, skin or casing. An ‘outer’ covering may refer to an exterior surface covering.

FIG. 1 illustrates a computing device 100 comprising an outer covering 102a, 102b and a fuel cell 104. The outer covering comprises a first portion 102a and a second portion 102b which are both integral with the outer covering.

The first portion 102a comprises an oxygen-permeable microstructure. That is, the first portion 102a comprises a material that is itself inherently permeable to oxygen because of its microstructure. Such a microstructure can allow oxygen to permeate through the outer covering without the requirement for visible apertures in the first portion 102a of the outer covering. An air-permeable microstructure is oxygen-permeable. In other examples, the entire outer covering could comprise an oxygen-permeable microstructure.

The microstructure of a material can be defined as the structure of the material that is invisible to the eye without an artificial means of magnification. The microstructure comprises microstructural features, such as apertures, cracks or pores. The microstructural features in the outer covering may have a mean length less than one of 0.1, 0.5, 1, 2, 5, 10 or 20 microns in their longest dimension in a plane of the exterior surface of the covering. A mean length of the features may be determined by examining a 1 mm² portion of the outer covering using a microscope at 100× or 10,000× magnification, for example.

The first portion 102a of the outer covering can be provided by a micro-perforated material. Examples of suitable substrate materials for the first portion 102a include metals such as stainless steel and aluminium, possibly with a protective coating, plastics, carbon fibre, porous glass and ceramics. Substrate materials could be metallic coated materials. Such materials can be prepared using, for example, a micro-milling technique such as laser cutting or ion-beam milling. Apertures in the first portion 102a of the outer covering may be arranged in an ordered pattern. Providing the apertures in an ordered arrangement has the benefit of providing greater uniformity to the mechanical properties of the outer covering and so reducing the possibility of the formation of weak points.

The outer covering 102a, 102b may be formed as a structural member on which internal components can be anchored. The outer covering 102a, 102b can be provided as a rigid material so as to offer protection to electronic components, such as computing components, and the fuel cell 104 within the device 100. That is, such an outer covering 102a, 102b does not deform in normal use. The outer covering 102a, 102b may also be formed of an impact resistant material to protect the fuel cell 104 and other electronic components of the device 100. Both or either of the first and second portions 102a, 102b of the outer covering may provide mechanical protection or structural support to electronic components within the outer covering.

The outer covering 102a, 102b may: have sufficient structural strength to apply compression to the cell; be formable or machinable to allow the case structure to be made; be thermally conductive to dissipate heat; have hydrophilic properties to remove or prevent the ingress of water; and be corrosion resistant.

The outer covering 102a, 102b may comprise a porous, or micro-porous, sintered material so as to provide one or more of the above desirable properties. Alternatively, the outer covering 102a, 102b may comprise a rigid fabric material.

As a further alternative, the outer covering 102a, 102b can be provided as a flexible material, such as a flexible fabric or skin.

The first portion 102a of the outer covering provides a physical/mechanical filter that prevents dust, particulates and macroscopic objects from entering the device 100. The provision of this physical filtering may also prevent or impede the penetration of liquids, such as water, into the device 100. The physical filtering of the outer covering can therefore reduce the probability of malfunction of the device 100 due to the ingression of external bodies. The first portion 102a may be coated with a hydrophobic material that prevents liquid from entering the device 100 but allows water vapour to escape from the device 100. Examples of hydrophobic materials include fluororesins such as Teflon® and Gore-Tex™.

The first portion 102a of the outer covering, or a layer (or layers) disposed on the first portion 102a within the outer covering, may also comprise a chemical filter in order to prevent undesirable chemicals that could poison the fuel cell 104 or damage other components from entering the device 100. Examples of chemical filter materials are activated carbon or platinum catalysts, as are known in the art. In addition, the filter may comprise one or more of a plastic membrane, such as a porous PTFE membrane, paper, silica gel, a woven material, a molecular sieve or a resin. The chemical filter can be configured to filter one or more of: aromatic compounds; hydrocarbons; carbon monoxide; sulphur compounds; volatile organic compounds (VOCs); oxides of nitrogen and particulate matter from an air stream passing between an exterior of the device 100 and the oxidant inlet 106 of the fuel cell 104.

In examples where the device 100 is a portable laptop computer, the breathable first portion 102a of the outer covering can be located in the lid of a display of the laptop or in the main body of the laptop.

The optional second portion 102b of the outer covering does not have an oxygen-permeable microstructure. That is, the microstructure of the second portion 102b is substantially non-oxygen-permeable. The oxygen permeability of the second portion 102b may be less than 0.1%, 1%, 10% or 25% of the permeability of the first portion 102a. Oxygen permeability can be assessed using ASTM D3985 05(2010)e1 “Standard Test Method for Oxygen Gas Transmission Rate Through Plastic Film and Sheeting Using a Coulometric Sensor”. The second portion 102b may be fabricated from a metal, such as aluminium or steel, or a high density plastic, and may be formed from the same material as the first portion 102a. The first and second portions 102a, 102b can be considered to be integrally formed with each other and/or with the outer covering as a whole if the first and second portions 102a, 102b are provided by the same material. Where the first portion 102a and the second portion 102b are formed of the same material, although the first portion 102a is chemically similar to the second portion 102b, the local microstructure of the material differs between the first and second portions 102a, 102b in order to impart different oxygen permeability in the respective portions 102a, 102b. The first portion 102a may therefore be similar in appearance to (or visibly indistinguishable to the naked eye from) the second portion 102b. In such examples, the outer covering may comprise only a single piece of material. That is, the outer covering may have a unitary structure. Where a unitary outer covering is provided the material of the outer covering can comprise a first portion 102a having an oxygen-permeable microstructure and a second portion 102b having a microstructure that is substantially non-oxygen-permeable. A conventional laptop case or mobile phone exterior housing material is an example of a suitable second portion 102b material.

Alternatively, where no second portion is provided, the first portion is considered to be integrally formed with the outer covering because the outer covering consists entirely of the first portion 102a.

The fuel cell 104 has an oxidant inlet 106 that is in fluid communication with the first portion 102a of the outer covering. In this way, oxygen from the air 108 can be provided to oxidant inlet 106 the fuel cell 104 through the outer covering 102a. A stack of fuel cells 104 may be provided. Any reference herein to “a fuel cell” can equally apply to “a fuel cell stack” or vice-versa.

Similar features provided by the various illustrated examples are provided with corresponding reference numerals.

FIG. 2 illustrates a device 200 comprising an outer covering 202 and a fuel cell 204. An oxidant inlet face 206 of the fuel cell 204 is integrated with the outer covering 202. That is, the oxidant inlet face 206 (which may also be referred to as a ventilation face) of the fuel cell is in contact with the oxygen-permeable outer covering 202. The outer covering 202, specifically the portion of the outer covering 202 that is integrated with the oxidant inlet face 206, may provide mechanical protection and/or structural support to the fuel cell 204. In another example, the outer covering 202 may provide one or more end plates, or compression plates, of a fuel cell stack.

The integrated fuel cell 204 provides a physical structure (or chassis) on which other electronic components (not shown) of the device 200 can be mounted. In this way, the construction of the device 200 can be simplified.

The fuel cell 204 can be a capillary action, air cooled fuel cell. Integration of the fuel cell 204 with the outer covering 202 allows cooling of the fuel cell 204 using principles similar to those of human skin cooling. The fuel cell 204 is configured to be cooled by a capillary action drawing water from an active membrane of the fuel cell 204 to evaporate at the surface without forced convection. Turbulent air 208 resulting from the evaporative cooling of the fuel cell is shown at the exterior of the outer covering 202. That is, the outer covering 202 may be hydrophilic in order to draw water from the fuel cell 204 and to evaporate it into the surrounding air.

In another example, the outer covering may have a hydrophilic core configured to wick water from the fuel cell. The outer covering of such an example may also have a hydrophobic coating to prevent water ingress into the device.

The device 200 addresses the objectives of:
providing structural integrity to the device 200 by integrating the fuel cell 204 and the outer covering 202, thereby providing a robust chassis for affixing other components;
increasing the efficiency of the fuel cell 204 by providing an entire face of the fuel cell 204 as a oxidant inlet face 206.
reducing heat management issues encountered by the device 200 by placing the fuel cell 204 within the outer facing part of the device 200, so as to allow evaporative cooling of the fuel cell 204.

The outer covering 202 of the device 200 is designed to dissipate heat from the fuel cell 204 by removing thermal energy from the fuel cell (or fuel cell stack) by conduction. That is, the outer covering is in thermal contact with the fuel cell and is configured to conduct heat from the fuel cell 204 so as to maintain a suitable operating temperature of the device 200.

FIG. 3 illustrates a device 300 comprising an outer covering 302a, 302b, 302c, a fuel cell 304, an electronic component 310 and a fan 312.

The outer covering 302a, 302b, 302c in this example comprises a third portion that has similar properties to the first portion. The first portion is also referred to below as an inlet portion 302a. Similarly, the third portion is referred to below as an outlet portion 302c.

The fan 312 is positioned adjacent to the inlet portion 302a of the outer covering, between the inlet portion 302a and the oxidant inlet 306 of the fuel cell 304. Alternatively, the fan 312 or a second fan could be positioned adjacent to the outlet portion 302c of the outer covering. The fan 312 is an optional example of a forced convection device that is configured to draw or direct air 308a into the device 300 through the inlet portion 302a of the outer covering. A first volume of the air 308b follows a first fluid flow path and provides convection cooling to the electronic component 310 by passing over a heat sink feature 314, such as a radiator fin, of the electronic component 310. The inlet portion 302a of the outer covering is configured to provide air as a coolant to the electronic component 310. A second volume of the air 308c follows a second fluid flow path and is provided to the oxidant inlet 306 of the fuel cell 304. The second volume of air 308c provides oxidant to the fuel cell and can also be used to provide convection cooling of the fuel cell. The first volume of air 308b that has passed over the heat sink feature 314, or the second volume of air 308c that has been expelled from an outlet of the fuel cell 304, is vented from the device 300 through the outlet portion 302c of the outer covering.

The fuel cell 304 can provide power to the electronic component 310 and the fan 312. An on-board battery (not shown) may also be provided within the device 300 to provide power to the electronic component 310 and the fan 312. The fuel cell 304 can be operated in a low power mode to recharge the on-board battery or in a high power mode. The high power mode can be used to either recharge the battery more rapidly or to provide power to operate the device 300.

FIG. 4 illustrates a device 400 similar to that illustrated in FIG. 3. However, in this example the fuel cell 404 of the device 400 is integrated with an inlet portion 402a of the outer covering in a similar way to that described in the example of FIG. 2. Also, in this example, the fan 412 is provided at outlet portion 402c of the outer covering, rather than at the inlet portion 402a. As a further alternative, a forced convection device may be provided anywhere in a fluid path between the inlet portion 402a and the outlet portion 402c of the outer covering in order to increase air flow through the outer covering 402a, 402c.

In another example, the outer covering may provide structural support to a fuel cell stack and provide one or more end plates, or compression plates, of the fuel cell stack.

It will be appreciated that features described with regard to one of the examples herein above may also be provided in combination with features of other examples.

1. A computing device comprising:
an outer covering having at least a first portion which is an oxygen-permeable microstructure, wherein the first portion is integrally formed with the outer covering;
an electronic component within the outer covering; and
a fuel cell with an oxidant inlet that is in fluid communication with the first portion of the outer covering.

2. The computing device of claim 1, wherein the first portion of the outer covering provides a structural support to the electronic component or the fuel cell.

3. The computing device of claim 1, wherein the first portion of the outer covering provides mechanical protection to the electronic component or the fuel cell.

4. The computing device of claim 2, wherein the first portion of the outer covering is rigid.

5. The computing device of claim 1, wherein the outer covering has a second portion which is a microstructure that provides a lower oxygen permeability than the first portion, wherein the second portion is integrally formed with the outer covering.

6. The computing device of claim 5, wherein the second portion has a substantially non-oxygen-permeable microstructure.

7. The computing device of claim 1, wherein the outer covering has no visible apertures.

8. The computing device of claim 1, wherein the outer covering is a unitary structure.

9. The computing device of claim 1, wherein the oxygen-permeable microstructure of the first portion comprises pores or apertures with a mean length less than one of 0.1, 0.5, 1, 2, 5, 10 or 20 microns in their longest dimension in a plane of the exterior surface of the covering.

10. The computing device of claim 6, wherein the pores or apertures are arranged in an ordered pattern.

11. The computing device of claim 1, wherein the outer covering comprises one or more of: a porous sintered material; carbon fibre; metallised porous plastic; pierced metallic material; a metal or alloy; porous graphite; woven metallic fibre;
metallised porous glass; stainless steel; aluminium possibly with protective coating; a plastic;
carbon fibre; a composite material; porous glass; a ceramic; or metallic coated materials.

12. The computing device of claim 1, wherein the oxidant inlet of the fuel cell is provided on an oxidant inlet face of the fuel cell, and wherein the oxidant inlet face of the fuel cell is integrated with the first portion of the outer covering.

13. The computing device of claim 1, further comprising a fan configured to direct air through the first portion of the outer covering into the oxidant inlet of the fuel cell.

14. The computing device of claim 13, further comprising a first fluid flow path and a second fluid flow path, wherein the first fluid flow path is provided between the fan and the electronic component, the second fluid flow path is provided between the fan and the oxidant inlet of the fuel cell, and wherein the fan is configured to direct air into the first and second fluid flow paths.

15. The computing device of claim 14, wherein the outer covering is in thermal contact with the fuel cell or the electronic component and is configured to conduct heat from the fuel cell or the electronic component so as to maintain a suitable operating temperature of the device.

16. The computing device of claim 13, further wherein the fan is situated between the first portion of the outer covering and the oxidant inlet.

17. The computing device of claim 1, wherein the first portion of the outer covering comprises a chemical filter.

18. The computing device of claim 1, wherein the first portion of the outer covering is configured to filter, from an air stream passing between an exterior of the outer covering and the oxidant inlet of the fuel cell, at least one of: aromatic compounds; hydrocarbons; carbon monoxide; sulphur compounds; volatile organic compounds (VOCs); oxides of nitrogen and particulate matter.

19. The computing device of claim 1, wherein the fuel cell is a fuel cell stack and the first portion of the outer covering provides a compression plate of the fuel cell stack.

20. The computing device of claim 1, wherein the outer covering has a hydrophilic core configured to wick water from the fuel cell and a hydrophobic coating to prevent water ingress into the device.

21. A computing device comprising:
an outer covering comprising a material having:
a first portion having an oxygen-permeable microstructure, and
a second portion having a microstructure that is substantially non-oxygen-permeable; and
a fuel cell with an oxidant inlet that is in fluid communication with the first portion of the outer covering.
